(19) United States
(12) Patent Application Publication
(10) Pub. No.: US 2010/0299640 A1
(43) Pub. Date: Nov. 25, 2010

(54) TRACKING IN A VIRTUAL WORLD

(75) Inventor: Tobin Titus, East Liverpool, OH (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/469,685

(22) Filed: May 21, 2009

(51) Int. Cl. G06F 3/048

(52) U.S. Cl. 715/848; 715/849

(57) ABSTRACT

A status update of a real world entity is received. A previous status of a virtual world entity is transformed into a current status of the virtual world entity based on the status update of the real world entity. The virtual world entity may be part of a virtual world and may correspond to the real world entity in a real world. Further, the virtual world entity and the virtual world may be generated by a computer.

### BACKGROUND

In recent years, massively multiplayer online (“MMO”) computer applications, such as massively multiplayer online role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

A virtual world may provide a way for participants to share real world information with other participants in the virtual world. For example, the virtual world may contain a status text feature whereby a participant can enter text regarding her status. Thus, if Jane is having lunch with Jack in the real world, Jane may update her virtual world status to state “Jane is having lunch with Jack”. The virtual world may then broadcast Jane's status text to other participants within the virtual world.

Status features, such as status text, are conventionally implemented in MMO and other applications as way to provide a limited social function. For example, the status text may enable a participant to share relevant and interesting information about her real world life with her virtual world friends. However, the utilization of status features outside of basic social applications has not been explored.

It is with respect to these and other considerations that the disclosure made herein is presented.

### SUMMARY

Technologies are described herein for providing real-time or near real-time tracking in a virtual world. As used herein, the term “tracking” generally refers to following the status of an entity (e.g., a participant, item, or process) within the virtual world and/or the real world. An entity in the virtual world may be referred to herein as a virtual world entity, as a virtual participant, virtual item, or virtual process. An entity in the real world may be referred to herein as a real world entity, such as a real participant, a real item, or a real process. According to embodiments, each virtual world entity in the virtual world may correspond to a particular real world entity in the real world. For example, the virtual world entity may be visual representation of the real world entity.

The status of an entity may include a variety of information, such as location, progress, condition, and the like. Thus, a change in status may refer to a change in location, progress, condition, and the like. When the status of a real world entity changes, then a corresponding virtual world entity may be updated to reflect the changed status of the real world entity. Further, when the status of a virtual world entity changes, then a real world process may be dictated according to the changed status of the virtual world entity.

According to one embodiment, a method is provided herein for providing tracking in a virtual world. A status update of a real world entity is received. A previous status of a virtual world entity is transformed into a current status of the virtual world entity based on the status update of the real world entity. The virtual world entity may be part of a virtual world and may correspond to the real world entity in a real world. Further, the virtual world entity and the virtual world may be generated by computer.

It should be appreciated that although the features presented herein are described in the context of a MMO computer application, these features may be utilized with any type of virtual world or environment including, but not limited to, other types of games as well as online social communities. It should also be appreciated that the above-described subject matter may also be implemented as a computer-controlled apparatus, a computer process, a computing system, or as an article of manufacture such as a computer-storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIG. 1 is a network architecture diagram showing aspects of a network architecture capable of implementing a virtual world, such as a massively multiplayer online application;

FIG. 2 is a flow diagram illustrating a method for updating the status of a virtual world entity to reflect a status update of a corresponding real world entity, in accordance with embodiments;

FIG. 3 is a flow diagram illustrating a method for dictating a real world process flow based on the status of a virtual world entity, in accordance with embodiments;

FIG. 4 is a flow diagram illustrating a method for updating a virtual representation of a package in a virtual world to reflect a status update of the package in the real world, in accordance with embodiments;

FIG. 5 is a flow diagram illustrating a method for dictating a real world package delivery process based on the virtual location of an avatar in a virtual world, in accordance with embodiments; and

FIG. 6 is a computer architecture diagram showing aspects of an illustrative computer hardware architecture for a computing system capable of implementing aspects of the embodiments presented herein.

### DETAILED DESCRIPTION

The following detailed description is directed to technologies for providing tracking in a virtual world. Through the utilization of the technologies and concepts presented herein, the status of real world entities in the real world and virtual world entities in the virtual world may be tracked in real-time or near real-time. Any status changes to real world entities in the real world may be mimicked by virtual world entities in the virtual world. Further, any status changes to virtual world entities in the virtual world may be utilized to dictate real processes in the real world.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

As used herein, the term virtual world refers to a computer-implemented environment, which may include simulated, lifelike environments as well as fanciful, non-existing environments. Examples of virtual worlds may include any massively multiplayer online (“MMO”) computer application including, but not limited to, massively multiplayer online role-playing games (“MMORPGs”), virtual social communities, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world may be inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, packages, and soda cans, as well as fanciful creations, such as a teleportation machine or a flying car. The avatars and the virtual objects utilized in the virtual world may or may not be animated images.

As used herein, a “real world entity” may refer to a participant, item, or process in the real world. According to embodiments, each real world entity corresponds to a “virtual world entity”, which may refer to a corresponding virtual representation of the participant, item, or process. For example, an avatar in the virtual world may correspond to a participant.

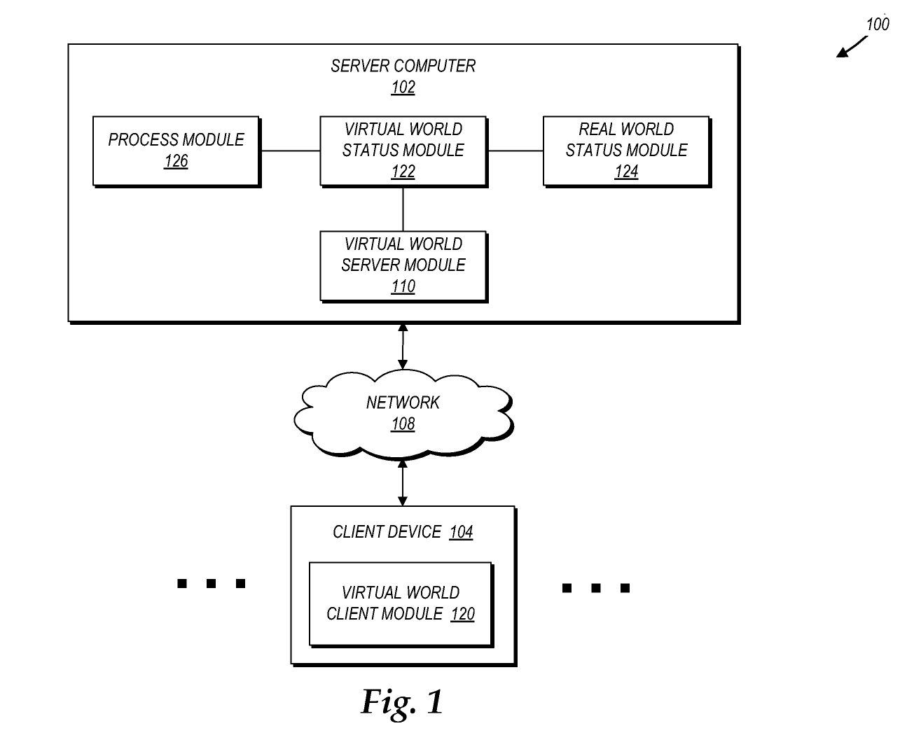

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for implementing a virtual world will be described. In particular, FIG. 1 illustrates a simplified network architecture 100 for implementing a virtual world. The network architecture 100 shown in FIG. 1 includes a server computer 102 and a client device 104, each of which is operatively coupled via a network 108. The network 108 may be any suitable network, such as a local area network (“LAN”) or the Internet. Although only one client device 104 is illustrated in FIG. 1, the network architecture 100 may include multiple client devices and multiple computing devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Example peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with a virtual world server module 110 executing on the server computer 102. In particular, the virtual world client module 120 may receive and process data from the virtual world server module 110 and output the data to output devices coupled to the client device 104. Further, the virtual world client module 120 may receive data from input devices coupled to the client device 104 and transmit the data to the virtual world server module 110.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience. It should be appreciated that a participant may be able to access the virtual world without “entering” the virtual world. For example, the participant may access the virtual world through a third party program (e.g., a social networking service, a blogging service, etc.) that is operative to access data from the virtual world.

As shown in FIG. 1, the server computer 102 includes the virtual world server module 110, a virtual world status module 122, a real world status module 124, and a process module 126. The virtual world server module 110 generally administers the virtual world and serves as a conduit between multiple client devices, including the client device 104. The virtual world status module 122 generally updates the status of a virtual entity in the virtual world. The real world status module 124 generally updates the status of a real world entity in the real world. The process module 126 may dictate a real life process based on input provided from the virtual world status module 122.

In some embodiments, updates to the status of a real world entity may be reflected in the corresponding virtual world entity. In particular, updates to the status of the real world entity may be received at the real world status module 124. The real world status module 124 may receive the status update through another computer or device (not shown) in an automated manner or through manual human input. Upon receiving the status update of the real world entity, the real world status module 124 may inform the virtual world status module 122 of the status update. The virtual world status module 122 may then update the status of the virtual world entity that corresponds to the real world entity. The virtual world status module 122 may cause the virtual world server module 110 to update the virtual world in order to reflect the status update of the real world entity.

In one embodiment, the virtual world server module 110 notifies each client, such as the virtual world client module 120, of the update to the virtual world. In another embodiment, the virtual world server module 110 stores the update to the virtual world in a database (not shown). In this way, the virtual world client module 120 may retrieve the update to the virtual world from the database as necessary.

In further embodiments, updates to the status of a virtual world entity may dictate a real world process. In particular, updates to the status of the virtual world entity may be received at the virtual world status module 122. The virtual world status module 122 may receive the status update through another computer or device (not shown) in an automated manner or through manual human input. As previously described, the virtual world status module 122 may also update the status of the virtual world entity based on input from the real world status module 124. Upon receiving the status update of the virtual world entity, the virtual world status module 122 may inform the process module 126 of the status update. The process module 126 may then dictate real processes based on the status update of the virtual world entity.

When a participant desires to access the virtual world, the participant may initiate the virtual world client module 120 to establish a session with the virtual world server module 110 via the network 108. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110.

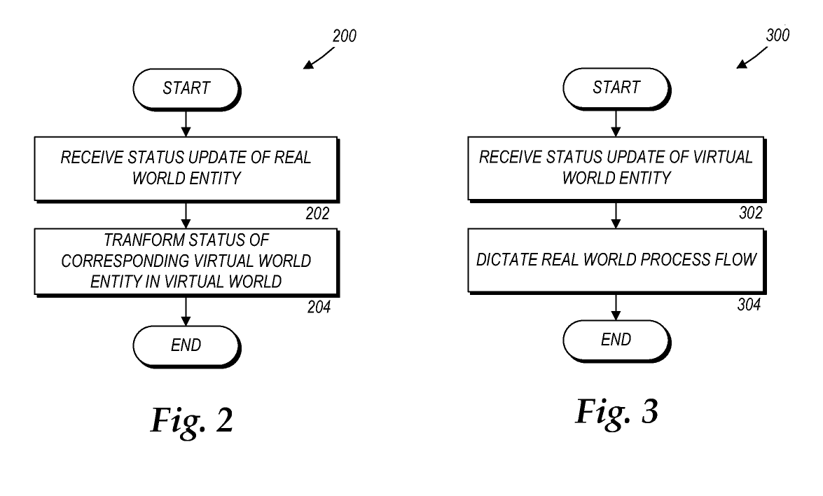

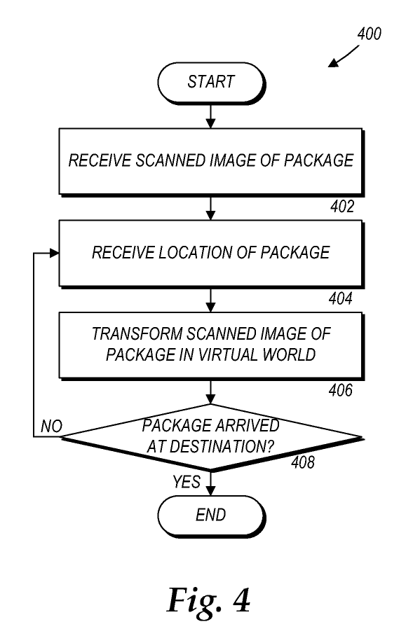

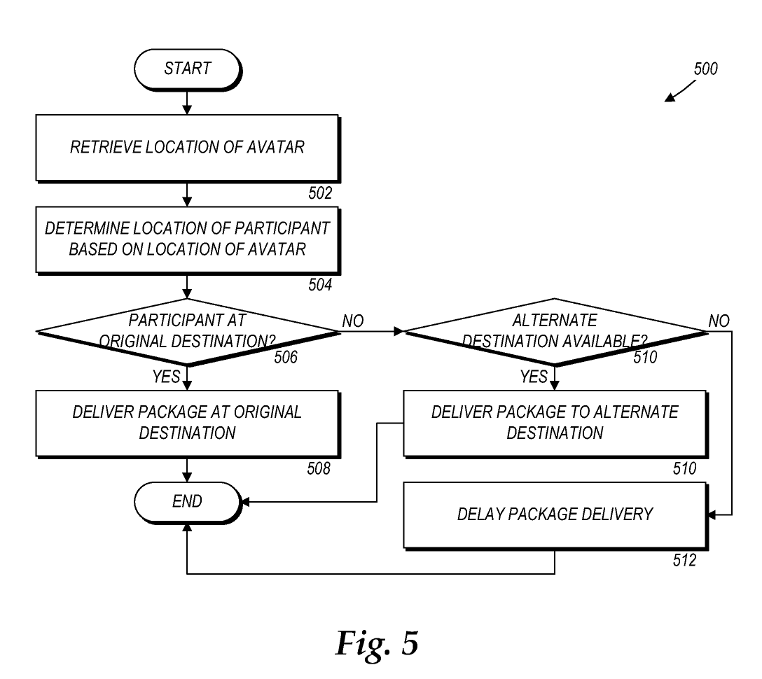

Referring now to FIGS. 2-5, additional details will be provided regarding the embodiments presented herein for providing real-time or near real-time tracking in a virtual world. In particular, FIG. 2 is a flow diagram illustrating a method for updating the status of a virtual world entity to reflect a status update of a corresponding real world entity. FIG. 3 is a flow diagram illustrating a method for dictating a real world process flow based on the status of a virtual world entity. FIG. 4 is a flow diagram illustrating an example implementation of the method of FIG. 2. In particular, FIG. 4 illustrates a method for updating a virtual representation of a package in a virtual world to reflect a status update of the package in the real world. FIG. 5 is a flow diagram illustrating an example implementation of the method of FIG. 3. In particular, FIG. 5 illustrates a method for dictating a real world package delivery process based on the virtual location of an avatar in a virtual world.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 2, a routine 200 begins at operation 202, where the real world status module 124 receives a status update of a real world entity. The real world entity may be any participant, item, or process in the real world. In this example, the status update may refer to any identifiable change to the real world entity. In some embodiments, the real world status module 124 receives the status update of the real world entity in an automated manner from another computer or device. In other embodiments, the real world status module 124 receives the status update of the real world entity through manual human input from another computer or device.

In one example, the status update of the real world entity may refer to a change in location of a participant. As the participant travels within the real world, the real world status module 124 may track any changes in location. In this case, the real world status module 124 may utilize a Global Positioning System (“GPS”) receiver on the participant's cellular device or other suitable technologies to determine the location of the participant. In another example, the status update may refer to a change in the condition of a package during transit. In yet another example, the status update may refer to a change in the delivery schedule or delivery location by a courier service. Numerous other status changes may be contemplated by those skilled in the art.

Upon receiving the status update of the real world entity, the real world status module 124 may inform the virtual world status module 122 of the status update. The routine 200 then proceeds to operation 204, where the virtual world status module 122 may update the virtual world based on the status update of the real world entity. In particular, the virtual world status module 122 may instruct the virtual world server module 110 to transform the status of a virtual world entity that corresponds to the real world entity.

In the previous example where the status update of the real world entity refers to a change in location of a participant, the virtual world status module 122 may instruct the virtual world server module 110 to transform the status of an avatar that corresponds to the participant. In particular, the avatar may be transformed to indicate that the location of the participant has changed and possibly the new location of the participant. For example, the virtual world may be designed to include a virtual representation of the person's home, office, and gym. As the participant travels from between her home, office, and gym, the participant's avatar may be correspondingly transformed to reflect whether the participant is at her home, office, or gym.

In the previous example where the status update of the real world entity refers to a change in the condition of a package during transit, the virtual world status module 122 may instruct the virtual world server module 110 to update the status of an animated image or model of the package in the virtual world. In particular, the animated image or model of the package may be altered to mimic the actual physical damage to the package. In this way, a user viewing the animated image or model in the virtual world can quickly identify that the real world package has been damaged.

In the previous example where the status update of the real world entity refers to a change in the delivery schedule or delivery location by a courier service, the virtual world status module 122 may instruct the virtual world server module 110 to update the status of an animated image of a real world delivery truck in the virtual world. In one example, if the delivery truck suffers a flat tire while performing deliveries, the animated image may be altered to show a virtual flat tire. In another example, as the delivery truck travels through its route to make deliveries, the animated image may be relocated across the virtual world to reflect the current location of the delivery truck.

Referring to FIG. 3, a routine 300 begins at operation 302, where the virtual world status module 122 receives a status update of a virtual world entity. The virtual world entity may be any virtual representation of the real world entity. The virtual world entity may be embodied in any suitable multimedia, such as text, images, audio, video, and combinations thereof. In this example, the status update may refer to any identifiable change to the virtual world entity. According to embodiments, the virtual world status module 122 receives the status update of the virtual world entity from the virtual world server module 110. For example, the status update of the virtual world entity may refer to a change in the virtual location of an avatar. As the avatar travels within the virtual world, the virtual world status module 122 may track any changes in virtual location. Numerous other status changes may be contemplated by those skilled in the art.

Upon receiving the status update of the virtual world entity, the virtual world status module 122 may inform the process module 126 of the status update. The routine 300 then proceeds to operation 304, where the process module 126 may dictate a real world process based on the status update received from the virtual world status module 122. In particular, the process module 126 may transform the real world process flow based on input from the virtual world status module 122.

In the previous example where the status update of the virtual world entity refers to a change in the virtual location of an avatar, the change in the virtual location of the avatar may reflect a change in the location of the corresponding participant. In this case, the process module 126 may transform the delivery destination of a package, based on the change in the virtual location of the avatar, in order to accommodate the change in the location of the participant.

Referring to FIG. 4, a routine 400 begins at operation 402, where the virtual world server module 110 receives a scanned image of a package to be delivered. The virtual world server module 110 may then insert the image of the package into the virtual world such that the package can be viewed through the virtual world client module 120. Once the virtual world server module 110 receives the image of the package, the routine 400 proceeds to operation 404.

At operation 404, the real world status module 124 receives a location of the package. In one example, the real world status module 124 receives the location of the package via a GPS device located at the delivery truck carrying the package. In another example, the real world status module 124 receives the location of the package from a manual location update from the delivery truck driver. In yet another example, the real world status module 124 receives the location of the package by accessing a location database associated with the package courier. Upon receiving the location of the package, the real world status module 124 may inform the virtual world status module 122 of the current location of the package. The routine 400 proceeds to operation 406.

At operation 406, the virtual world status module 122 updates the scanned image of the package based on the location of the package. In particular, the virtual world status module 122 may instruct the virtual world server module 110 to transform the display of the scanned image in the virtual world to reflect the change in location of the package. The routine 400 then proceeds to operation 408, where a determination is made as to whether the package has arrived at its destination. If the package has not yet arrived at its destination, then operations 406-408 may be repeated. That is, the virtual world status module 122 may continue to transform the scanned image of the package based on the most current location of the package. If the package has arrived at its destination, then the routine 400 terminates.

In the example of FIG. 4, the virtual world may include a graphical interface that mimics a source location from which the package is initially retrieved, a destination location to which the package is to be delivered, and a delivery route between the source location and the destination location. When the package is initially retrieved by a delivery truck driver, the graphical interface may show the package at the source location. As the delivery truck travels across the delivery route, the virtual world server module 110 may transform the virtual world to show that location of the package across the delivery route. When the package is delivered, the graphical interface may show the package at the destination location.

Referring to FIG. 5, a routine 500 begins at operation 502, where the virtual world status module 122 retrieves a location of an avatar in the virtual world. In particular, the virtual world status module 122 may retrieve the location of the avatar from the virtual world server module 110. According to embodiments, the avatar in the virtual world corresponds to a participant in the real world. The routine 500 then proceeds to operation 504, where the virtual world status module 122 determines the real location of the participant based on the virtual location of the avatar. For example, virtual locations in the virtual world may be designed to mimic actual locations in the real world. In this way, a person viewing a virtual location in the virtual world may be able to easily determine the corresponding location in the real world. Once the virtual world status module 122 determines the real location of the participant based on the virtual location of the avatar, the routine 500 proceeds to operation 506.

At operation 506, the virtual world status module 122 determines whether the participant is located at the original destination where the package is intended to be delivered (e.g., the delivery address written on the package). If the virtual world status module 122 determines that the participant is located at the original destination where the package is intended to be delivered, then the virtual world status module 122 may inform the process module 126 that the participant is located at the original destination. The routine 500 then proceeds to operation 508, where the process module 126 maintains the original delivery route where the delivery truck driver delivers the package at the original destination.

If the virtual world status module 122 determines that the participant is not located at the original destination where the package is intended to be delivered, then the routine 500 proceeds to operation 510, where the virtual world status module 122 further determines whether the participant is located at or near an alternate destination where the package can still be delivered. For example, there may only be certain authorized or permission locations where the package can be delivered. Further, the participant may permit or restrict deliveries to predefined locations.

If the virtual status module 122 determines that the participant is located at an alternate destination where the package can still be delivered, then the virtual status module 122 may inform the process module 126 that the participant is located at an alternate destination. The process module 126 may transform the original delivery route that included the original destination into an alternate delivery route that replaces the original destination with the alternate destination. The routine 500 then proceeds to operation 512, where the process module 126 implements the alternate delivery route so that the delivery truck driver delivers the package to the alternate destination.

If the virtual status module 122 determines that the participant is not located at an alternate destination where the package can still be delivered, then the virtual status module 122 may inform the process module 126 that the participant is located somewhere that is not the original destination or a suitable alternate destination. The process module 126 may then transform the original delivery route by suspending the delivery of the package until a later time.

In another example, if a courier service has shipped a package and the courier service has set rules in a virtual world that indicate if the package is damaged (e.g., through the animated image or model). If a determination is made that the package has been damaged, then the assigned delivery route may be halted such that damage to the package can manually examined before proceeding. Such a manual inspection may prevent further damage to the package. In this example, the virtual world status module 122 may inform the process module 126 of the condition or damage of the package. The process module 126 may then alter the delivery route or delivery process according to the condition or damage or the package.

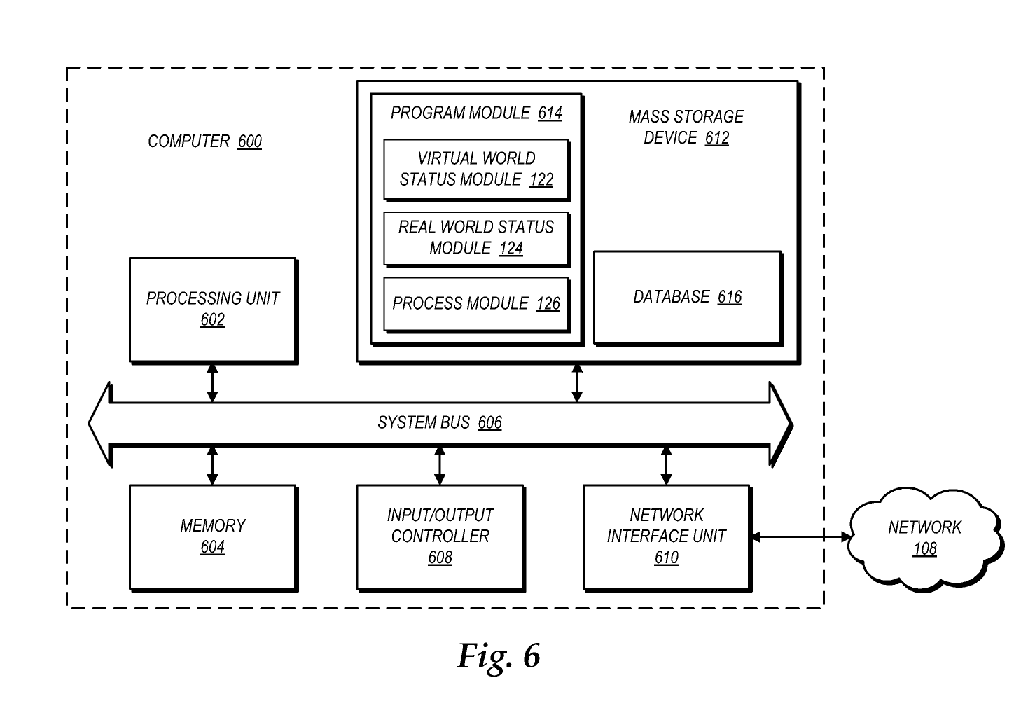

Referring now to FIG. 6, an exemplary computer architecture diagram showing aspects of a computer 600 is illustrated. Examples of the computer 600 may include the server computer 102 and the client device 104. The computer 600 includes a processing unit 602 (“CPU”), a system memory 604, and a system bus 606 that couples the memory 604 to the CPU 602. The computer 600 further includes a mass storage device 612 for storing one or more program modules 614 and one or more databases 616. Examples of the program modules 614 include the virtual world status module 122, the real world status module 124, and the process module 126. The mass storage device 612 is connected to the CPU 602 through a mass storage controller (not shown) connected to the bus 606. The mass storage device 612 and its associated computer-storage media provide non-volatile storage for the computer 600. Although the description of computer-storage media contained herein refers to a mass storage device, such as a hard disk or CD-ROM drive, it should be appreciated by those skilled in the art that computer-storage media can be any available computer storage media that can be accessed by the computer 600.

By way of example, and not limitation, computer-storage media may include volatile and non-volatile, removable and non-removable media implemented in any method or technology for storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 108. The computer 600 may connect to the network 108 through a network interface unit 610 connected to the bus 606. It should be appreciated that the network interface unit 610 may also be utilized to connect to other types of networks and remote computer systems. The computer 600 may also include an input/output controller 608 for receiving and processing input from a number of input devices (not shown), including a keyboard, a mouse, a microphone, and a game controller. Similarly, the input/output controller 608 may provide output to a display or other type of output device (not shown).

The bus 606 may enable the processing unit 602 to read code and/or data to/from the mass storage device 612 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 614 may include software instructions that, when loaded into the processing unit 602 and executed, cause the computer 600 to facilitate non-linguistic interaction with users via surface stimulation. The program modules 614 may also provide various tools or techniques by which the computer 600 may participate within the overall systems or operating environments using the components, flows, and data structures discussed throughout this description. For example, the program modules 614 may implement interfaces that facilitate non-linguistic interaction between the computer 600 and any number of users.

In general, the program modules 614 may, when loaded into the processors 106 and executed, transform the processing unit 602 and the overall computer 600 from a general-purpose computing system into a special-purpose computing system customized to facilitate non-linguistic interaction with computer systems via surface stimulation. The processing unit 602 may be constructed from any number of transistors or other discrete circuit elements, which may individually or collectively assume any number of states. More specifically, the processing unit 602 may operate as a finite-state machine, in response to executable instructions contained within the program modules 614. These computer-executable instructions may transform the processing unit 602 by specifying how the processing unit 602 transitions between states, thereby transforming the transistors or other discrete hardware elements constituting the processing unit 602.

Encoding the program modules 614 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 614 may transform the physical state of the semiconductor memory, when the software is encoded therein. For example, the program modules 614 may transform the state of transistors, capacitors, or other discrete circuit elements constituting the semiconductor memory.

As another example, the computer-storage media may be implemented using magnetic or optical technology. In such implementations, the program modules 614 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for providing tracking in a virtual world are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing tracking in a virtual world, the method comprising computer-implemented operations for:
receiving a status update of a real world entity; and
transforming a previous status of a virtual world entity into a current status of the virtual world entity based on the status update of the real world entity, the virtual world entity being part of a virtual world and corresponding to the real world entity in a real world, the virtual world entity and the virtual world being generated by a computer.

2. The computer-implemented method of claim 1, wherein receiving a status update of a real world entity comprises receiving the status update of the real world entity from another computer or device.

3. The computer-implemented method of claim 1, wherein receiving a status update of a real world entity comprises receiving a real location of the real world entity from a Global Positioning System (GPS) device.

4. The computer-implemented method of claim 1, wherein receiving a status update of a real world entity comprises receiving a scanned image of a package from an image scanning device.

5. The computer-implemented method of claim 1, wherein the real world entity comprises a real participant, a real item, or a real process in the real world; and wherein the virtual world entity comprises a virtual participant, a virtual item, or a virtual process in the virtual world; the virtual participant corresponding to the real participant, the virtual item corresponding to the real item, and the virtual process corresponding to the real process.

6. The computer-implemented method of claim 1, wherein the status update of the real world entity comprises a current real location of the real word entity; and wherein transforming a previous status of a virtual world entity into a current status of the virtual world entity based on the status update of the real world entity comprises transforming a previous virtual location of a virtual world entity into a current virtual location of the virtual world entity, the current virtual location corresponding to and mimicking the current real location.

7. The computer-implemented method of claim 1, wherein the status update of the real world entity comprises a current real condition of a real package; and wherein transforming a previous status of a virtual world entity into a current status of the virtual world entity based on the status update of the real world entity comprises transforming a previous virtual condition of a virtual package into a current virtual condition of the virtual package, the current virtual condition of the virtual package corresponding to and mimicking the current real condition of the real package.

8. The computer-implemented method of claim 1, wherein the status update of the real world entity comprises a current real state of a real process; and wherein transforming a previous status of a virtual world entity into a current status of the virtual world entity based on the current state of the real process comprises transforming a previous virtual state of a virtual process into a current virtual state of the virtual process, the current virtual state of the virtual process corresponding to and mimicking the current real state of the real process.

9. The computer-implemented method of claim 1, wherein receiving a status update of a real world entity comprises receiving the status update of the real world entity in real-time or near real-time.

10. A computer system comprising:
a processor;
a memory operatively coupled to the processor; and
a program module (i) which executes in the processor from the memory and (ii) which, when executed by the processor, causes the computer system to provide tracking in a virtual world by
receiving a status update of a virtual world entity, and
dictating a real process by transforming a previous process flow of the real process into a current process flow of the real process in accordance with the status update of the virtual world entity, the virtual world entity being part of a virtual world and corresponding to the real world entity in a real world.

11. The computer system of claim 10, wherein receiving a status update of a virtual world entity comprises receiving the status update of the virtual world from a virtual world server module, the virtual world server module operative to provide the virtual world across a network.

12. The computer system of claim 10, wherein receiving a status update of a virtual world entity comprises receiving an indication that an avatar in the virtual world has moved from an original virtual destination to an alternate virtual destination, the avatar being controlled by a participant in the real world, the original virtual destination corresponding to and mimicking an original real destination in the real world, the alternate virtual destination corresponding to and mimicking an alternate real destination in the real world.

13. The computer system of claim 12, wherein the real process comprises a package delivery process, the package delivery process comprising a first delivery route for delivering a package to the original real destination.

14. The computer system of claim 13, wherein dictating a real process by transforming a previous process flow of the real process into a current process flow of the real process in accordance with the status update of the virtual world entity comprises dictating the package delivery process by transforming the first delivery route for delivering the package to the original real destination into a second delivery route for delivering the package to the alternate real destination.

15. The computer system of claim 13, wherein dictating a real process by transforming a previous process flow of the real process into a current process flow of the real process in accordance with the status update of the virtual world entity comprises delaying the package delivery process until the participant returns to the original real destination from the alternate real destination.

16. The computer system of claim 10, wherein receiving a status update of a virtual world entity comprises receiving the status update of the virtual world entity in real-time or near real-time.

17. The computer system of claim 10, wherein the real world entity comprises a real participant, a real item, or a real process in the real world; and wherein the virtual world entity comprises a virtual participant, a virtual item, or a virtual process in the virtual world; the virtual participant corresponding to the real participant, the virtual item corresponding to the real item, and the virtual process corresponding to the real process.

18. A computer-storage medium having computer-executable instructions stored thereon which, when executed by a computer, cause the computer to:
receive, through a real world status module, a status update of a real world entity from another computer or device;
communicate the status update from the real world status module to a virtual world status module;
transform, through the virtual world status module, a previous status of a virtual world entity into a current status of the virtual world entity based on the status update of the real world entity, the virtual world entity being part of a virtual world and corresponding to the real world entity in a real world; and
communicate the transformed current status of the virtual world entity from the virtual world status module to a virtual world server module, the virtual world server module operative to render the virtual world.

19. The computer-storage medium of claim 18 having further computer-executable instructions stored thereon which, when executed by a computer, cause the computer to:
receive, through the virtual world status module, a second status update of a virtual world entity;
communicate the second status update from the virtual world status module to a process module; and
dictate, through the process module, a real process by transforming a previous process flow of the real process into a current process flow of the real process in accordance with the second status update of the virtual world entity.

20. The computer-storage medium of claim 18, wherein the real world entity comprises a real participant, a real item, or a real process in the real world; and wherein the virtual world entity comprises a virtual participant, a virtual item, or a virtual process in the virtual world; the virtual participant corresponding to the real participant, the virtual item corresponding to the real item, and the virtual process corresponding to the real process.
